(19) United States
(12) Patent Application Publication
(10) Pub. No.: US 2026/0100635 A1
(43) Pub. Date: Apr. 9, 2026

(54) PARTIAL ENERGY PROCESSING CONVERTERS FOR A HIGH EFFICIENCY AND FULL MPPT RANGE PV MODULE INTEGRATED CONVERTER MIC

(71) Applicant: The Governors of the University of Alberta, Edmonton (CA)

(72) Inventors: Sayed Ali Khajehoddin, Edmonton (CA); Mohammad Daryaei, Edmonton (CA)

(21) Appl. No.: 19/115,225

(22) PCT Filed: Sep. 26, 2023
(86) PCT No.: PCT/CA2023/051271

§ 371 Date: Mar. 25, 2025

Related U.S. Application Data
(60) Provisional application No. 63/410,143, filed on Sep. 26, 2022.

(51) Int. Cl. H02M 1/00; H02M 3/158; H02S 40/32

(52) U.S. Cl. CPC H02M 1/0077; H02M 1/0058; H02M 1/0064; H02M 1/0074; H02M 1/0093; H02M 3/158; H02S 40/32

(57) ABSTRACT

In this patent document, the partial energy processing (PEP) concept is developed to achieve a high-efficiency and full MPPT range PV MIC. For PEP the energy is flown from the source to the load through multiple paths. The total energy then is divided into arbitrary portions in power-time plane and each portion is transferred through a different path to achieve the best conversion performance. A three path PEP structure that is specifically suitable for PV MIC application is proposed and realized in component level. A 220 W prototype converter is implemented to justify the converter principal of operation and analyses. Using the proposed PV MIC, MPPT is achieved for the full range of the PV power generation while 99.6% to 96.5% efficiency is achieved for the power mismatches in the PV module ranging from 0 to 50% of the maximum module power generation capability, respectively. The efficiency drop is shown to be linear with power mismatch level without any abrupt reductions that is commonly observed in conventional PV module integrated converters.

### TECHNICAL FIELD

Power converters.

### BACKGROUND

Photovoltaic (PV) solar energy is one of the promising renewable energy resources for which the solar energy is directly converted to electricity. PV modules generate dc voltage in the range of several tens of volts and require both voltage elevation and dc-ac conversion before they can be connected to the ac utility grid.

Efficiency and power density of Power Electronics converters has been constantly increased for decades and is projected to further improve. As an example, the efficiency at rated power for converters used in telecommunication and PV applications has increased from around 90% in 1990s to about 98% in recent years which has also contributed to the increase of converter power density. Specifically, for PV converters, not only the rated power efficiency must be increased but also converters must perform Maximum Power Point Tracking (MPPT) at module level to increase the energy yield in presence of module level power mismatches. Therefore, module level converters may be adopted for PV systems where the converter efficiency for the whole MPPT range becomes an important design factor. Furthermore, to fit the module level PV converters in the panel's junction box and to reduce the manufacturing costs module level converters must have a high power density.

Photovoltaic (PV) Module Integrated Converters (MICs) perform maximum power point tracking (MPPT) for individual PV panels and improve the system energy capture efficiency. The efficiency of the MIC and its MPPT range are key factors that determine the suitability of MICs for PV systems. Conventional PV MICs are either full power converters (FPC) or partial power converters (PPC) which suffer from low efficiency and small MPPT range, respectively.

Furthermore, the power generation of a PV module is dependent on the electrical characteristic of its load and maximum power which is called maximum power point (MPP) is obtained for one specific load characteristic. The MPP of PV modules changes with temperature and irradiation changes, thus maximum power point tracking (MPPT) may be applied on PV modules to extract the maximum energy.

In a PV system, power converters are employed to perform the dc-ac conversion and MPPT. The voltage elevation can be obtained either through the series connection of the PV modules or by means of power converters. Various PV system configurations are presented in the literature based on the series connection of the PV modules or voltage elevation through power converters.

FIGS. 1-4 show some of the most common PV system configurations 10. In the basic PV system configuration, shown in FIG. 1, multiple PV modules 12 are connected in series to build up a string 16 with a high dc voltage that is suitable for the dc-ac converter 18 which in the example shown produces an overall AC output 20. It would also be possible for a PV system to generate an overall DC output. In the examples shown in FIGS. 1-3, each PV module 12 may substantially comprise a solar panel 14, with no converter at the module level. Then, parallel combination of some of these high dc voltage strings 16 is connected to a central inverter to perform the dc-ac conversion. This configuration has the lowest power processed by the conversion stage, however, has poor energy capture performance. As a result of series connections, all PV modules 12 in each string 16 have equal currents. However, due to the power mismatch, each module may have a different maximum power point (MPP) and consequently a different MPP current. Therefore, in the presence of power mismatch, some of the modules will operate away from their MPP in this configuration resulting in the reduction of captured energy. Power mismatch between modules is the difference between their MPPs which is caused by multiple factors including nonuniform shading, soiling, aging, temperature gradients, etc. In the central inverter configuration shown in FIG. 1, the loss of extractable power may be caused by the power mismatch between different PV strings 16 as well, in which the overall voltage of each string is required to be the same due to the parallel connections, but at any single voltage the resulting currents differ from the overall optimal current for at least some string 16. Depending on the extent of power mismatch in a PV system, up to 30% of the annual extractable energy can be lost in string/central inverter configurations as shown in FIG. 1. To overcome the string level power mismatch other configurations are also presented as shown in FIG. 2 and FIG. 3. In the configuration shown in FIG. 2, each string 16 is connected to a string inverter 22 to perform the dc-ac conversion separately and in the configuration shown in FIG. 3 which is called multistring or two-stage PV system configuration, the strings 16 are equipped with string-level dc-dc converters 24 and multiple strings are then paralleled to increase the power level while only one dc-ac stage is used with overall DC-AC converter 18. Despite its usefulness in addressing string level power mismatches using the string level dc-dc converters 24 or per string dc/ac inversion with string inverters 22, these configurations are not able to address the module level power mismatches.

There is also another configuration for which the voltage control, here in the form of elevation, is obtained by means of power electronic converters. This category includes paralleled PV modules 12 equipped with the high step-up dc-dc converters 26 and microinverters 28 which is shown in FIG. 4. This configuration can overcome the module level power mismatch however it requires a dc-dc converter with a high voltage conversion ratio. High voltage gain converters usually suffer from high component stresses and low efficiencies. PV system configurations that adopt microinverters and paralleled PV modules equipped with the high step-up dc-dc converters 26 are from this category, and these kind of system configurations normally provide lower efficiencies compared to the rest of PV system configurations.

For the configurations with series stack of PV modules the energy loss due to power mismatch can be prevented by equipping each PV module 12 with a dc-dc converter as shown in FIGS. 5-7. These dc-dc converters are known as dc-dc module integrated converters (MICs).

dc-dc MICs in the literature are used with the PV panels series stack configuration which require voltage gains close to unity and are divided into two categories of full and partial power converters (FPC and PPC). FIGS. 5-7 shows different PV system configurations 10 with these MICs. FPCs 30, as shown in FIG. 5, process all the power of their PV panels 14 regardless of mismatch condition in the system, thus they have significant losses and a power rating equal to the PV panels rated power. Furthermore, FPC efficiencies drop significantly when the voltage gain deviates from unity. For a commercialized example it is shown that efficiency decreases from 98% to 96% when the voltage gain is reduced form unity to 0.75. Decreased power efficiency decreases the portion of MPP power that is available at PV MIC output after performing MPPT, thus it decreases the energy capture. The energy capture is integration of power over time and for most of the time FPCs operate away from unity gain where the power efficiency is decreased. Therefore, the FPCs efficiency drop with voltage gain deviations causes a significant loss in energy capture. PPCs comprise of two subcategories of parallel-PPC, shown in FIG. 6, and series-PPC, shown in FIG. 7. The parallel-PPCs 32 shown in FIG. 6 are connected in parallel with the PV panels and perform MPPT by shuffling currents among them. Parallel-PPCs are widely referred to as Differential Power Processing (DPP) converters in the literature and are implemented using various configurations and topologies. DPP converters improve system efficiency by processing only part of the nominal power and can have smaller rated power than their PV panels. However, there are disadvantages for the DPP converters that have limited their commercial application. Due to the shuffling of currents among converters, the total power processed by converters in some of DPP configurations increases significantly with the increase of the number of panels in a string which diminishes the merits of partial power processing. DPP configurations normally require an extra high-current DC wiring between panels or between panels and the de bus which increases the cost and adversely affects reliability and efficiency. In most DPP configurations, every string only has one MPP voltage and paralleling strings is not possible without an extra converter. Furthermore, as DPP converters are connected in parallel with the PV panels they normally operate with rated PV voltage and low current for which power converters exhibit low efficiency due to the power independent losses. The other subcategory of the PPC is series-PPC, shown in FIG. 7, for which a controlled voltage is added in series with the PV voltage to perform MPPT. The series-PPC 34 processes part of the PV panels power and as such preserves all the merits of DPP, while it does not have DPP disadvantages. In a series-PPC configuration, every panel's voltage can be controlled regardless of other MICs, as with an FPC configuration. A series-PPC 34 can comprise a converter 62 arranged with an IPOS arrangement (left) or with an ISOP arrangement (right). The power processed by each MIC only depends on its associated panels power mismatch. Therefore, unlike DPP, in the series-PPC configuration, total power processed by each of the converters does not increase with the increase of the number of panels in the string. No extra wiring among panels or DC bus is added in this configuration because all connections are connected within the converter. Parallel operation of the strings without extra converters is feasible as the series-PPCs can equalize string voltages while performing MPPT for every panel. For maintaining efficiency when MPPT for all panels changes (for example in dim light) the DC-AC inverter 18 may adjust the overall bus voltage and the series PPC MICs will adjust themselves to accommodate whatever bus voltage is applied. The inverter can do maximum efficiency tracking by finding the bus voltage that is best in terms of output power as this bus voltage will change the operating point and efficiency of the system. Since the series-PPC 34 is in series with the PV panel 14 it operates with low voltage and rated PV current most of the times and as such it can be optimized to have good partial load efficiency. Also, the power processed by series-PPC is zero if a unity voltage gain is required for the MPPT, and it is increased if the deviation of the voltage gain from unity is increased. Therefore, merits of the partial power processing for a series-PPC become negligible if extreme power mismatches are considered. As an example, it is possible in a PV system for a panel to have zero power generation while the rest of the panels operate at their rated power. In such conditions, output voltage for the series-PPC 34 of the shaded panel 14 must be zero. Therefore, series-PPCs 34 must be designed for a wide range of voltage gains including the zero which results in a converter rating equal to an FPC 30.

MICs perform maximum power point tracking (MPPT) for each PV module and increase the system energy capture. However, as the components used in MICs are not ideal, some energy is dissipated in the MICs. The energy loss of the MICs is added to the PV system losses and compromises part of the energy capture gain obtained using the module level MPPT. Thus, to justify the inclusion of the MICs from the energy capture point of view, it is crucially important to improve the efficiency of the MICs. Efficiency of the MICs in turn depends on their configuration and topology. Most of the existing literature adopt conventional configurations (such as FPC and PPC) and topologies for MIC implementation which suffer from low efficiency and limited MPPT range.

### SUMMARY

In this patent document, the various voltage conversion ratio operations of module integrated dc-dc converters are analyzed. For this analysis, the common PV system dc-ac converters i.e., constant and variable de bus voltage inverters, are considered. It has been shown that step-down series-PPCs are beneficial for both constant voltage and variable voltage dc bus PV systems.

In this patent document, the partial power processing concept is extended to the partial energy processing (PEP) concept in some embodiments to attempt to solve the challenges of the series-PPCs. According to the PEP concept, the energy flows from the source to the load through multiple paths. The total energy then is divided into arbitrary portions in the power-time plane and each portion is transferred through a different path to achieve the best conversion performance. Not all the paths need to be real power converters and a dummy bypassed converter which is simply a direct wired connection of the input and output terminals can be used as one of the paths to improve the efficiency. Furthermore, in some embodiments, some components can be shared among the converters to achieve a low-cost implementation.

Using the PEP concept, in some embodiments, a novel structure is proposed for a PV MIC application which consists of three energy paths. One of the paths is a dummy bypassed converter which transfers the largest portion of the energy and results in improved MIC efficiency. The other two paths are power converters that share all their components to reduce the component count. Each converter is operated with the dummy bypassed converter in pair. The two resulting pairs are optimized for efficiency and have fixed conversion ratios. The conversion ratio of the overall PEP structure is controlled by adjusting the time duration that each pair is operating. The conversion ratios of the pairs are designed to cover the wide range of the voltage gains required for PV MIC. Lower voltage gains are obtained by one of the pairs while the larger gains are obtained using the other pair. Therefore, voltage and current ratings of the converters are kept small, and their efficiencies are improved while the MIC performs the MPPT for the full range of PV panel power from zero to the rated power. The PEP-based PV MIC is designed to cover the voltage gains in the range of zero to unity while it achieves high efficiencies.

A soft-switching and high-frequency topology which has a simple structure and can provide zero voltage conversion ratio is adopted in some embodiments to realize the PEP-based MIC in component level. A special gating scheme is used for the converter to achieve soft switching operations. Furthermore, the effects of switch output capacitances have been investigated in this patent document. It is shown that switch capacitances resonate with the leakage inductance when the switch is turned off and causes voltage spikes and oscillations on switches, which may reduce the efficiency specifically in high frequency applications. Two clamp diodes are employed to effectively suppress the voltage spikes, and to restore the energy of the leakage inductance once the switch capacitances are charged to the desired voltage. A 1 MHz prototype MIC was built, and magnetic design bottle necks were identified and optimized using a novel modelling approach for the transformer.

Embodiments of the method described herein differ from conventional partial power processing because of the presence of multiple energy paths between the source and the load. Another difference is in the way the method controls the power converter to obtain the desired conversion ratio. In embodiments of the proposed method, the conversion ratio for each of the paths is constant to optimize efficiency while obtaining various conversion ratios through two different means:
1. Utilizing the flexibility that various possible configurations provide in a multiple path partial energy processing converter.
2. Time control of the operation of converter using each of the constant conversion ratio paths.

In conventional partial power processing techniques, there are generally only two possible configurations which are commonly referred to as IPOS and ISOP. By contrast, using multiple path partial energy processing there are several possible configurations which are shown in FIGS. 13A-13F for a three-path example. In the conventional partial power processing, each of the two possible configurations have a total conversion ratio that relates to the real power converter conversion ratio as follows:

$$\begin{matrix}{M}_{IPOS} = 1 \pm {M}_{conv} \\ {M}_{ISOP} = 1 \pm \frac{1}{{M}_{conv}}\end{matrix}$$

As can be seen, once the configuration is chosen for conventional partial power processing there is usually no way other than converter conversion ratio control to adjust the total conversion ratio. However, in multiple-path PEP there are multiple real converters, and their conversion ratios contribute to the total conversion ratio. The way that the total conversion ratio is related to the conversion ratio of the real converters depends on the combination of the converters that are used at the same time and depends on the configuration. As an example, each of the real converters may be used in pair with the dummy converter in a three-path PEP. Accordingly, there are six possible configurations and for each configuration there are two conversion ratios available. For example, in configuration C1, shown in FIG. 13A and FIG. 14, the two conversion ratios are:

$${M}_{pair 1} ( C 1 ) = 1 \pm {M}_{conv 1} and {M}_{pair 2} ( C 1 ) = 1 \pm {M}_{conv 2}$$

While, configuration C2, shown in FIG. 13B, has the following conversion ratios:

$${M}_{pair 1} ( C 2 ) = 1 \pm \frac{1}{{M}_{conv 1}} and {M}_{pair 2} ( C 2 ) = 1 \pm {M}_{conv 2}$$

The total conversion ratio depends on the pairs' conversion ratios and the pairs' conversion ratios themselves depend on the real converter conversion ratio. As an example, regarding configuration C1, it can be seen that by selecting two different values for the conversion ratio of real converter 1 and 2, one can have two different conversion ratios for the pairs. Also, one can get different pair conversion ratios even using the same real converter conversion ratio as can be seen from the configuration C2 conversion ratios. This way part of total conversion ratio control is done by selecting the appropriate configuration and the constant conversion ratios for each of the used real power converters.

The other part of the conversion ratio control is done by time controlling the converter operation using each of the pairs. Assume that for configuration C1, M_{conv1}=0.5 and M_{conv2}=1 are chosen. Then using the positive output polarity converters, the conversion ratio of the pairs are:

$${M}_{pair 1} = 0.5 and {M}_{pair 2} = 0.$$

An obvious operating mode on top of pair 1 and pair 2 operation is the no real power converter mode operation which means only using the dummy converter that results in M=1. Now having these three conversion ratios any conversion ratio between 0.5 and 1 is obtained by operating the converter in pair 1 mode, which may be referred to as process mode, and in the mode using the dummy converter, referred to as pass-through mode. Also, any conversion ratio between 0 and 0.5 is obtained by operating the converter in pair 2 (which may be referred to as bypass mode) and pair 1 (pass-through) modes. Appropriately allocating the time for each of the mentioned modes of operation gives the ability of sweeping the conversion ratio between 0 and 1.

Notably, in the above example, only the operation of the real converters in pair with the bypass path were used however there are other feasible modes that also could be used. For example, operating all energy paths together is another feasible operating mode which may give even more options for modes of operation to better adjust the total conversion ratio of the PEP structure.

### BRIEF DESCRIPTION OF THE FIGURES

FIG. 1 is a schematic diagram of a prior art PV system configuration with a central inverter.

FIG. 2 is a schematic diagram of a prior art PV system configuration with string inverters.

FIG. 3 is a schematic diagram of a prior art PV system configuration with a two-stage inverter.

FIG. 4 is a schematic diagram of a prior art PV system configuration with micro-inverters.

FIG. 5 is a schematic diagram of a prior art PV system configuration with full power converters (FPC)

FIG. 6 is a schematic diagram of a prior art PV system configuration with parallel partial power converters.

FIG. 7 is a schematic diagram of a prior art PV system configuration with series partial power converters, with the series partial power converters shown in additional detail at lower left with an IPOS arrangement and at lower right with an ISOP arrangement.

FIG. 8 is a graph showing a triangular allocation of the total transferred energy in a Partial Energy Processing (PEP) configuration with two paths.

FIG. 9 is a schematic diagram showing a PEP configuration with three energy flow paths.

FIG. 10 is a graph showing an example energy allocation of the total transferred energy in the PEP configuration of FIG. 9.

FIG. 11 is a schematic diagram showing a PEP configuration including a dummy converter.

FIG. 12A is a schematic diagram showing an invalid wire connection for the configuration of FIG. 11, where converter 1 and the dummy converter are in a PIPO configuration when converter 2 is off.

FIG. 12B is a schematic diagram showing an invalid wire connection for the configuration of FIG. 11, where converter 1 and the dummy converter are in a SISO configuration when converter 2 is off.

FIG. 13A-13F are schematic diagrams showing practically valid configurations of the PEP configuration of FIG. 11.

FIG. 14 is a schematic diagram showing the configuration of FIG. 13A with positive ground.

FIG. 15 is a schematic diagram showing a string of PV panels along with their converters which have inductive output filters in series, the inductive filters represented using a single inductive filter.

FIG. 16A is a circuit diagram showing a realization of the converter 1 and dummy converter of FIG. 14.

FIG. 16B is a circuit diagram showing a realization of the converter 2 and dummy converter of FIG. 14.

FIG. 17 is a circuit diagram showing a combination of the circuits of FIG. 16A and FIG. 16B to provide a realization of the configuration of FIG. 14.

FIG. 18 is a circuit diagram showing a simplified version of the realization shown in FIG. 17.

FIG. 19A is a schematic diagram showing the converter of FIG. 18 operating in a pass-through mode.

FIG. 19B is a schematic diagram showing the converter of FIG. 18 operating in a bypass mode.

FIG. 19C is a schematic diagram showing the converter of FIG. 18 operating in a process mode.

FIG. 20 is a circuit diagram showing the converter of FIG. 18 operating in the pass-through mode.

FIG. 21 is a circuit diagram showing the converter of FIG. 18 operating in the bypass mode.

FIG. 22 is a chart showing switching schemes, intervals and waveforms for the converter of FIG. 18 operating in process mode.

FIGS. 23A-23F are circuit diagrams showing the operation of the converter of FIG. 18 in intervals M1-M6 respectively, as shown in FIG. 22.

FIG. 24 is a picture of an experimental prototype of a converter.

FIG. 25 is graph showing zero voltage switching waveforms for a switch corresponding to Q₁ of the converter of FIG. 18 in the prototype shown in FIG. 18.

FIG. 27A is a graph showing switching waveforms for Q₁ of the prototype when operating with N_{pdm}=20.

FIG. 27B is a graph showing switching waveforms and input current ripple for Q₃ of the prototype when operating with N_{pdm}=20.

FIG. 28A is a graph showing switching waveforms for Q₁ of the prototype when operating with N_{pdm}=12.

FIG. 28B is a graph showing switching waveforms and input current ripple for Q₃ of the prototype when operating with N_{pdm}=12.

FIG. 29 is a graph showing efficiency of the prototype in relation to different mismatches between panels, for different nominal input voltages

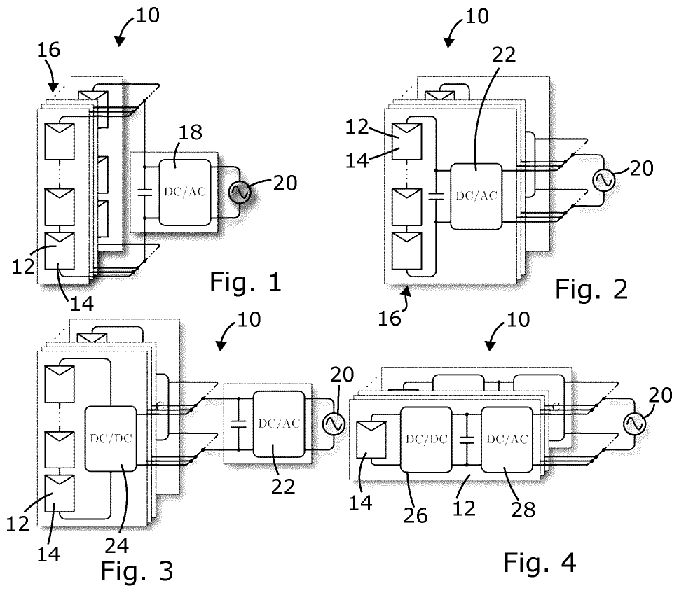

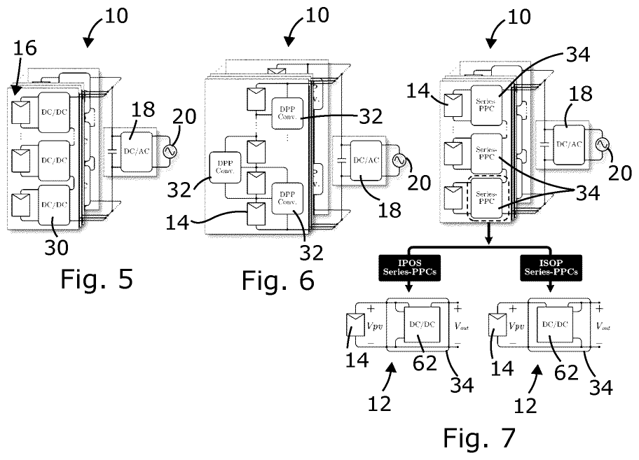

### DETAILED DESCRIPTION

### Partial Energy Processing (PEP) Concept

### Extension of Partial Power Processing to Partial Energy Processing Concept

The concept of partial power processing is based on providing two or more power flow paths from the source to the load and transferring each part of the total power through one of the paths. In this concept, power flow path is a two-port network and can be considered as a general power converter. One of the power flow paths is normally more efficient than the other and is used to transfer the largest part of the power. Much of the existing art for the partial power processing is based on simultaneous operation of the two converters where the instantaneous power of each converter is equal to its average power, all the time. To improve the overall efficiency, one of the converters is normally realized as an ultra-efficient converter with fixed conversion ratio, while the other converter regulates the output by processing smaller power compared to a full power converter. In the most common configurations, one of the power flow paths is realized as a dummy bypassed converter with 100% efficiency to obtain the maximum overall efficiency when operating close to unity conversion ratios. By using the dummy converter as one of the converters for partial power processing, there are only two feasible structures of input parallel output series (IPOS) or input series output parallel (ISOP). In some embodiments described herein, the concept of partial power processing is extended to partial energy processing (PEP). A single source single load configuration is qualified as PEP if:
There is more than one path for energy flow from the source to the load,
The energy flow between the source and the load is divided into at least two portions and each portion is transferred through a different path.

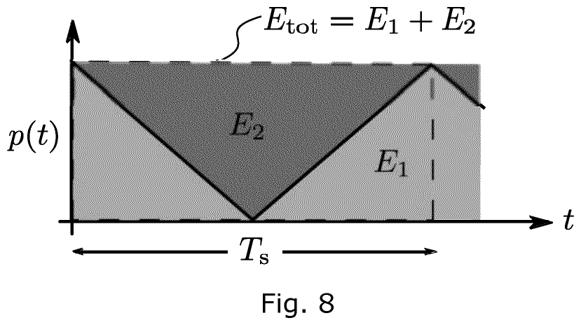

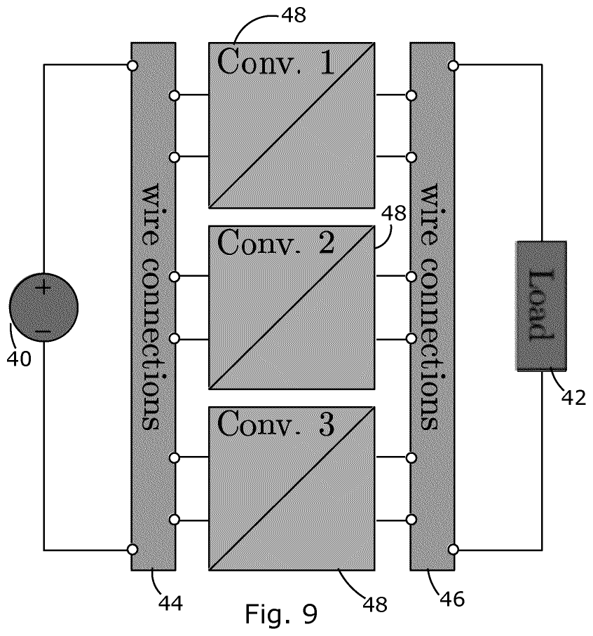

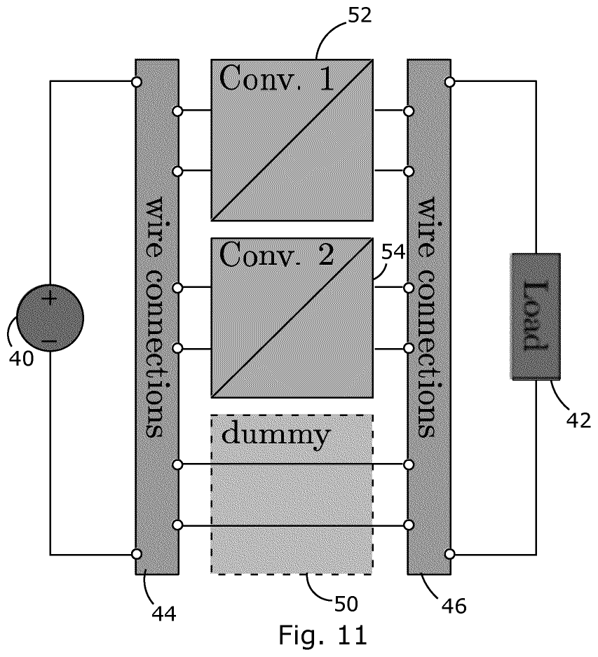

It is important to note that the energy that flows from the source to the load equals to the area enclosed between source/load instantaneous power and the time axis as it is shown in FIG. 8 for example. The allocation of this area to each of the converters can be done in many ways to serve different optimization goals. As an example, consider a PEP configuration with two paths. If the energy flow is divided into two triangular areas as shown in FIG. 8, the configuration can resemble two interleaved PWM converters with reduced filter requirements which operate at DCM boundary to achieve soft switching. Another example is to divide the energy flow into two rectangles which resembles the basic partial power processing concept under which one of the rectangular portions of energy can be transferred through a dummy converter. A PEP configuration can also have three energy flow paths, as shown in FIG. 9, where any shape of three energy portions serves as an example. As shown in FIG. 9, a PEP configuration connects a source 40 to a load 42 through three converters 48 which provide the three energy flow paths. The converters are connected to the source through input side wire connections 44 and to the load by output side wire connections 46. The input and output side wire connections can be connected via wires in the converters 48, which is particularly of note in the case of one of the converter being a dummy converter 50 (as shown in FIG. 11) with direct wire links between the input side wire connections and output side wire connections.

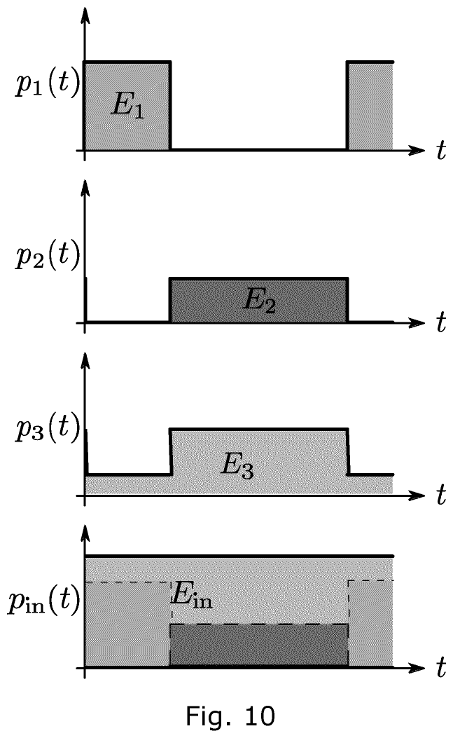

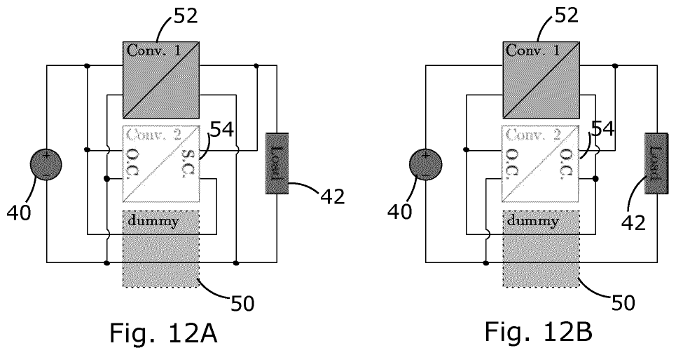

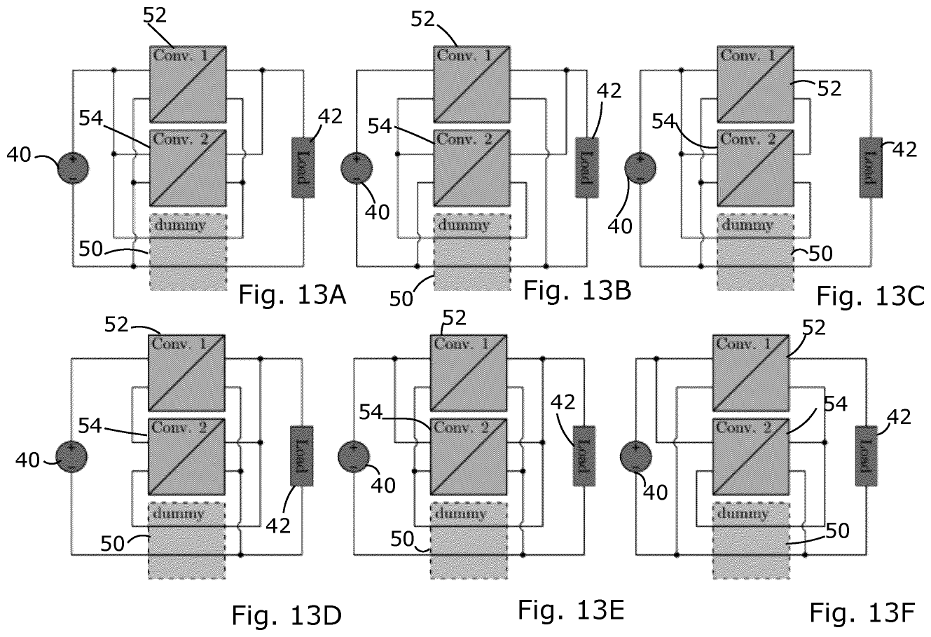

One useful example would be dividing the energy flow into rectangular portions as shown in FIG. 10 and using a dummy converter to transfer the largest portion (e.g. the portion labeled E3). On top of the loss free energy transfer through the dummy converter, this PEP configuration allows converters to operate in pairs. Each pair consists of only one of the converters and the dummy converter. Then each of the converters are operated at two power levels only and can be optimized to have the best operation and efficiency at these power levels. Therefore, using embodiments of this PEP structure, the efficiency of the basic partial power processing can be further improved. Leveraging the PEP concept and substituting one of the converters 48 by a dummy converter 50 as shown in FIG. 11, a new structure is invented for PV converters which can be considered an extension of the series-PPC. Therefore, the source 40 would be a dc voltage source representing the PV panel and the load 42 can be either a de voltage or a current source representing the rest of the converters in the string and the dc-ac inversion stage. In case of using the invented MIC the rest of the PVs and converters, represented along with the load seen by a string as a whole as load 42, act as a current source since it uses an inductive filter at string side. According to FIG. 11, efficient converter pairs that can be used for energy transfer are: pair1 consisting of a first converter 52 and the dummy converter 50, and pair 2 consisting of a second converter 54 and the dummy converter 50. When one pair is operating, the remaining converters terminals should be either a short or open circuit depending on the wire connections among converter terminals. In general, terminals of the three converters can be connected in parallel or series and there are several wire connections possible for the PEP configuration shown in FIG. 11. However, some of the connections have no practical value because they may lead to parallel input and parallel output (PIPO) or series input and series output (SISO) connection between one of the converters and the dummy converter. The only converter that can be in a PIPO or SISO configuration with a dummy converter is another dummy converter, resulting in a direct connection from source to load. Therefore, the wire connections leading to PIPO and SISO with the dummy converter are considered practically invalid. FIG. 12A and FIG. 12B show two examples of invalid wire connections. The pair of first converter 52 and dummy converter 50 which is used with second converter 54 in the OFF state has PIPO and SISO connections in FIG. 12A and FIG. 12B respectively. If the invalid connections and replicas are removed, there are 6 practically valid configurations for the PEP structure shown in FIG. 11. These 6 configurations can be categorized into two groups where the first group configurations have at least one IPOS pair and the second group configurations have at least one ISOP pair. FIGS. 13A-13F show these 6 configurations. The configurations are referred to using labels C1-C6 as follows: FIG. 13A shows configuration C1, with pair 1 and pair 2 as IPOS; FIG. 13B shows configuration C2, with pair 1 as ISOP and pair 2 as IPOS; FIG. 13C shows configuration C3, with pair 1 and 2 as IPOS; FIG. 13D shows configuration C4, with pair 1 and 2 as ISOP; FIG. 13E shows configuration C5, with with pair 1 as IPOS and pair 2 as ISOP; and FIG. 13F shows configuration C6, with pair 1 and 2 as ISOP. Configurations C₁ to C₃ have at least one IPOS pair and configurations C₄ to C₆ have at least one ISOP pair. The difference between these 6 configurations is the ISOP or IPOS connection of their pairs and the way that the remaining converter is operating at its OFF state. For example, C1 and C2 each have different IPOS or ISOP connection in their pairs. As another example, C1 and C3 have the same IPOS connections in their pairs, however they have different OFF state converter operation.

In C1, both the input and output terminals are open circuit when the converters are in their OFF state, but in C3 the input terminal is open circuit and the output terminal is short circuit when the converters are in their OFF state. The IPOS or ISOP connection of the pairs plays a vital role in the converter realization. The preferred state of the converter terminals when it is off depends on the application specifications. For example, if the efficiency is of crucial importance, the open circuit terminal would be more beneficial as the converter does not have any losses for an open circuit terminal, while the short circuit terminal has conduction losses associated with the current passing through the short circuited terminal. On the other hand, for applications in which the terminal voltage stress is critical, the short circuit terminals for the converter OFF state is more beneficial.

### PEP Based Converter for PV MIC

In this section, the PEP concept is leveraged in some embodiments to develop a power converter that can replace existing PV MICs. This PEP-based converter preserves all the benefits of series-PPCs and tackles the drawbacks that were associated with the wide MPPT range operation. A voltage step-down type converter is preferred in some embodiments as it reduces the overall system cost by accommodating more panels per string compared to a voltage step-up type converter. Also, a converter with both step-up and step-down is not considered suitable in some embodiments as it is less efficient and operates away from its unity gain to keep the inverter dc bus voltage constant. As a result, a significant portion of the captured energy is processed with low conversion efficiencies offsetting any gain obtained from employing the constant voltage inverter.

For a voltage step-down PV MIC, the voltage gain (M) range required to cover all extreme mismatch cases that can occur in PV systems is:

$$0 \leq M \leq 1. \qquad ( 3.1 )$$

However, most or the captured energy in a PV system is processed with a close to unity voltage gain (M) as suggested by field studies. Also, the range of the converter voltage gain for which the greatest portion of the energy is processed depends on the mismatch conditions in the PV system. For applications with light mismatch conditions, the voltage gains for which the large portion of the captured energy is processed are in a narrow range around M=1. Whereas, for the heavy mismatch conditions, this range is relatively large around M=1. Voltage gain range also needs to include small values and even M=0 as they might happen in PV systems with mismatch but with lower probability. Therefore, a suitable converter for the step-down PV MIC must be able to cover 0≤M≤1 while it ideally provides the greatest efficiency for voltage gains close to unity. Also, the range at which converter has the most efficient operation may be flexible to be changed based on application. This flexibility in the high-efficiency operation range renders an extra degree of freedom to further improve the converter efficiency in the desired range. In this section, embodiments of an appropriate configuration of the three path PEP structure to realize the PV MIC with the discussed voltage gain capabilities is described. As shown in FIGS. 13A-13F, various PEP configurations are all composed of ISOP and IPOS pairs only. Thus, the pros and cons of realizing the PV MIC using each of ISOP and IPOS connections is addressed first to facilitate the selection of the appropriate PEP configuration. In a PV MIC, the source is a PV panel operating at its MPP and as such has relatively constant voltage equal to the rated MPP voltage (V_{MPP}). However, the panel current may vary from zero to the rated MPP current (I_{MPP}). The load current is equal to the string current which is normally set to I_{MPP} by means of inverter voltage adjustment. Setting the string current to I_{MPP} makes most of the MICs to operate with unity gain and have higher efficiency. The load voltage for each panel can vary between zero and V_{MPP} to cover the voltage gain range from zero to 1. By using the IPOS connection between the PV panel and the string, the PV side would be the voltage sourced terminal of the converter and the string side would be the current sourced terminal of the converter. Thus, the converter used for IPOS has a constant voltage at the voltage terminal and a constant current at the current sourced terminal. The ISOP connection on the other hand yields to a converter with the voltage of voltage sourced terminal varying from 0 to V_{MPP} and the current of current sourced terminal varying from 0 to I_{MPP}. Operating a voltage sourced terminal with zero voltage and current sourced terminal with zero current causes realization challenges such as unwanted DCM operation and EMI problems. Furthermore, the current sourced terminal of the IPOS is on the string side of the converter, which is in series with other converters, while the current sourced terminal of the ISOP is on the PV side and each current source is only connected to its own PV panel. Therefore, the IPOS configuration gives the opportunity to reduce the inductive filter requirements by sharing the inductance of the converters with a possible inductance used in the dc bus side for other purposes. Also, interleaved operation of the converters is feasible in the IPOS configuration which further reduces the inductive filter size. It can be concluded that from a converter realization point of view, the IPOS connection better suites the PV panel and string configuration requirements.

Among the valid configurations of a three path PEP structure with a dummy converter, C1 and C3 are composed of IPOS connections only and are therefore considered especially suitable for the PV MIC realization for the above reasons. For the off-state operation of the converter in C1, both input and output terminals are open circuit which helps to reduce conduction losses. However, for the off-state operation of the converter in C3, output terminals must be short circuit which causes extra conduction losses compared to C1. In C1, both input and output terminals of the converters are in parallel, while the output terminals of converters in C3 are connected in series. Thus, the first converter 52 and second converter 54 in C1 can share switching components and energy storage elements in both input and output terminals. However, for C3 the reference potential of the output switching components and energy storage elements are different in the first converter 52 and second converter 54. As a result, in C3, the first converter 52 and second converter 54 cannot share as many components as they can in C1. Therefore, the most appropriate configuration for the PV application is considered to be C1 which is used to realize the PV MIC in the next section.

### Realization of the PEP Based PV MIC

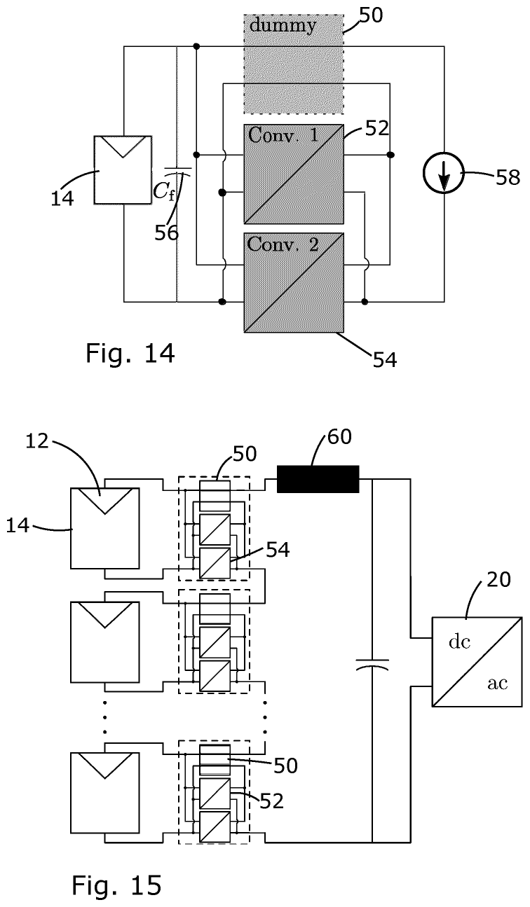

In this section, C1 is adopted to build the voltage step-down PV MIC. In the version of C1 shown in FIG. 13A, the negative terminals of the source and the load are connected together as the common ground. The order of converters in C1 can be swapped to make the structure a positive ground configuration where the positive terminals of the load and the source are connected together. The positive ground connection of C1 is shown in FIG. 14 which can eliminate the switch gate isolation requirements and is used to realize the voltage step-down PV MIC. It is important to note that in FIG. 14 the source 40 shown in FIG. 13A is replaced with a PV panel 14 and its capacitive filter 56, and the load 42 is replaced with a current source 58 representing the string behavior. In C1, the current-sourced output terminals of the converters, which are realized using inductive filters, are connected in series with the load. Thus, the combination of all inductive filters of the converters is seen from load terminal, resulting in a large inductive filter. As shown in FIG. 15, this combination of inductors can be realized using a single inductor 60 on the string, and the string behavior can be modeled by a current source (58, shown in FIG. 14). In component level, this configuration can be realized in various ways; however, all the realizations of C1 must have the following features:
At least one of the first and second converters must have galvanic isolation to avoid short circuit problems and to avoid loss of partial energy processing merits at the component level.
The first and second converters must each have a current sourced terminal at the string side and a voltage sourced terminal at the PV side.

The above specifications and limitations depend on the converter topology and the selected configuration. In general if a configuration creates a short circuit in the topology that converter should be isolated.

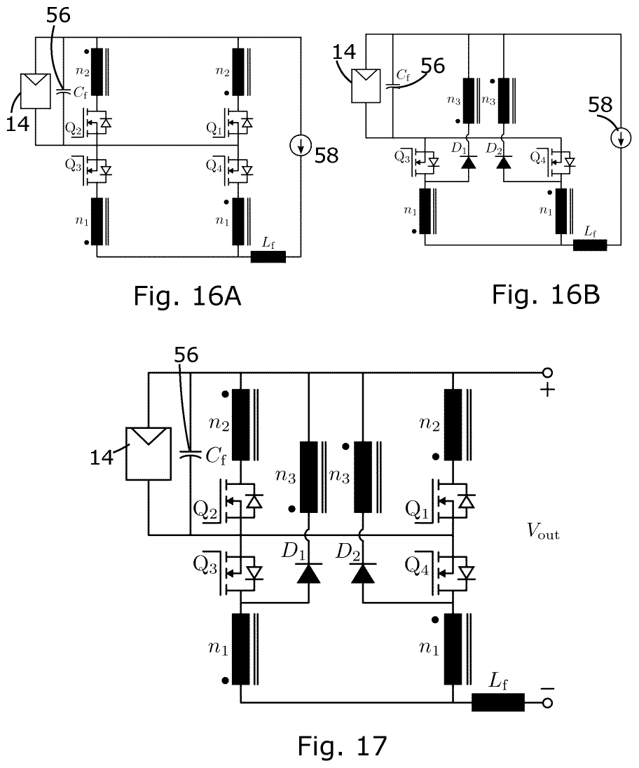

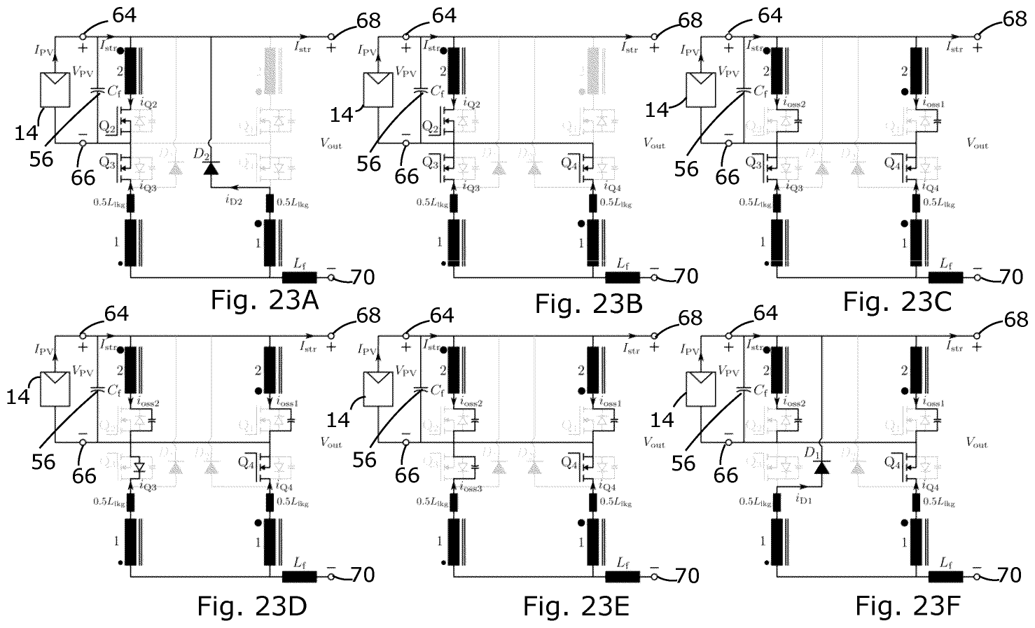

FIGS. 16A and 16B shows one realization for pair 1 (shown in FIG. 16A) and pair 2, (shown in FIG. 16B) where all windings are wound on the same magnetic core. This realization uses the positive ground C1 configuration in a three converter PEP structure as shown schematically in FIG. 14 As can be seen in FIGS. 16A and 16B, the output voltage is equal to the input voltage plus the extra voltage generated at the bottom by the converter. The dummy converter is realized in the wiring arrangement, and has the effect of the input voltage appearing at the output directly and providing power to the output, and the converter output provides extra voltage, where needed, by processing some power taken from the input and passing to the output which can be achieved in several different intervals and states as described below, for example in FIGS. 23A-23F.

As can be seen from FIG. 16A and FIG. 16B, pair 1 and pair 2 have the inductive filter Lf, the windings with m number of turns and switches Q₃ and Q₄ in common. Thus, they can be collected into one converter as shown in FIG. 17.

### Soft-Switching High-Frequency Realization of the Proposed MIC

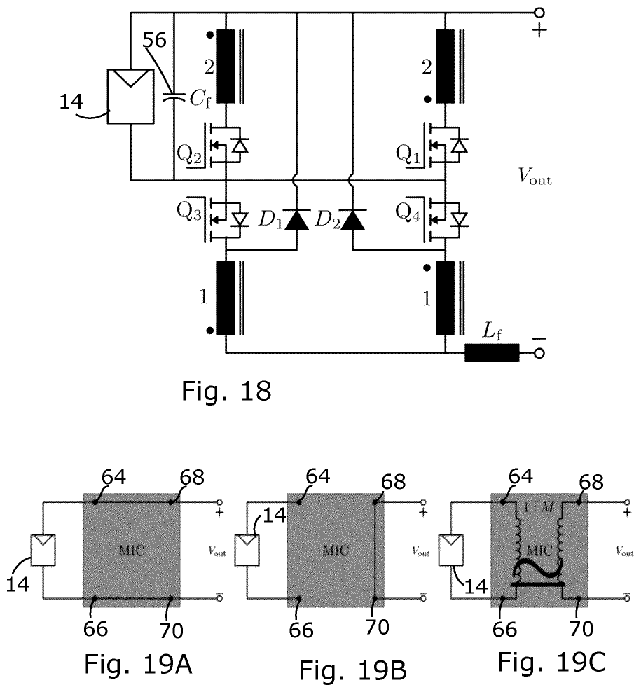

The general realization of a particular example of the PV MIC would be as shown in FIG. 17, however some simplifications are still possible. The inductor If can be removed from converters and be replaced by a larger single inductor on the inverter dc bus. The turns ratio used for the transformer are as n₂=N₂/N₁ and n₃=N₃/N₁ which can be designed based on the converter operating mode requirements. For a specific operating mode, diodes D₁ and/2 are used to clamp the voltages across the switches Q₃ and Q₄. For this operating mode, n₃ is selected as N₃=2N₁-N₂ to be able to clamp the OFF state voltages of (3 and (4 to the PV voltage. If m₂=2 for this operation, then n₃ becomes zero and two windings can be saved in realization. Therefore, using these turn ratios, MIC realization is simplified as shown in FIG. 18. It is important to note that all the switches are on the same ground and there is no need for power isolation for gate driving of the proposed converter. Furthermore, the inductor can be integrated with the transformer in some embodiments to reduce the size and cost and improve the efficiency. To perform MPPT, normally MICs are controlled using the duty cycle and/or frequency control which is not efficient for the entire load/voltage range. Using the PEP concept can improve the efficiency of the MICs and their MPPT range. The two pairs of the PEP based MIC can be operated using ON and OFF control mode (i.e., burst mode) to implement the PEP concept and optimize the efficiencies of the converters. Pair 1 and 2 can be designed to have their lowest voltage gain in ON mode and their largest voltage gain in their OFF mode. Then, a range of voltage gains are obtained by combining the ON and OFF mode operation of pairs 1 and 2 while the larger voltage gains are achieved through mostly OFF mode operation of the converters which improves the efficiency, referred to below as “pass-through mode”.

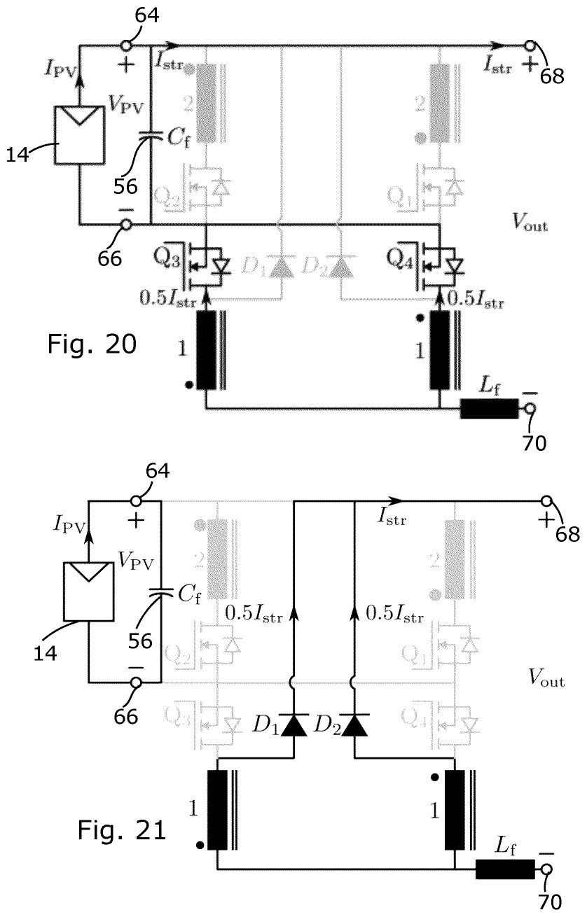

The ON and OFF mode operation of the pairs are determined by the on and off state of the switches on the PV and string side. Both pair 1 and pair 2 OFF mode operation leads to short circuit on the string side terminal and open circuit on the PV side terminal, as shown in FIG. 20, referred to as “pass-through mode”. Then, string side switches Q₃ and Q₄ must be turned on and PV side switches Q₁ and Q₂ must be turned off for OFF mode operation of the pairs. As pair 1 and pair 2 have the string side switches Q₃ and Q₄ in common, the same switches would turn on for both the pair 1 and pair 2 OFF modes while the rest of the switches Q₁ and Q₂ are turned off. Therefore, the pair 1 and 2 OFF modes results in the same circuit. The ON modes however are different for pair 1 and pair 2 leading to three different modes of operation for the PEP based PV MIC in total. The PEP-based PV MIC operates in one of these three modes for each switching period. Also, it ensures the PV panel is operating at its maximum power point (MPP) by regulating the time duration for each of these modes per a sequence of switching periods. The three modes of operation for the proposed MIC are shown in FIG. 19A, FIG. 19B and FIG. 19C in the MIC's high-level representation. In this representation, the MIC is shown as having a positive input terminal 64, negative input terminal 66, positive output terminal 68, and negative output terminal 70. The first mode, shown in FIG. 19A, is obtained by imposing pair 1 and pair 2 to their OFF states where the energy flow from the PV to the string is through the dummy converter. Therefore, this mode is called pass-through mode which simply connects the PV module to the output as if there is no conversion at all. The conversion ratio of the pass-through mode is 1. The second mode, shown in FIG. 19B, is obtained by imposing pair 1 and pair 2 to their OFF and ON states, respectively, which is called bypass mode. The bypass mode bypasses the output terminal while leaving the PV module open-circuit, thus results in a conversion ratio of 0. The third operating mode, shown in FIG. 19C is obtained by imposing pair 1 and pair 2 to their ON and OFF states, respectively, which is called process mode. As pair 1 is a soft-switching converter at constant conversion ratio, the MIC in the process mode acts as a DC transformer with constant conversion ratio 0<M<1. Then, any conversion ratio between M and 1 can be obtained by proper allocation of the time to pass-through and process modes while conversion ratios between 0 and M are obtained by time allocation between bypass and process modes.

Converter operation in each of these modes is described as follows:

### Pass-Through Mode

FIG. 20 shows the converter circuit in Pass-through mode. In this mode, switches Q₁ and Q₂ are turned-off and switches Q₃ and (4 are turned-on causing clamp diodes D₁ and D₂ to be reverse-biased. In this mode, the capacitive filter is discharged by −(Iₛₜᵣ−I_{PV}) current whereas, the inductive filter is charged by V_{PV}−Vₒᵤₜ voltage. If the converter stays in this mode for an adequately long time, filters let Iₛₜᵣ=I_{PV} and Vₒᵤₜ=V_{PV}, thus MIC voltage gain becomes 1.

### Bypass Mode

In Bypass mode, all switches (Q₁,Q₂,Q₃, and Q₄) are turned-off and clamp diodes D₁ and D₂ are forced to conduct the string current Iₛₜᵣ. The MIC equivalent circuit for Bypass mode is shown in FIG. 21. In this mode, the capacitive filter is charged by the PV current I_{PV} whereas, the inductive filter is discharged by −Vₒᵤₜ voltage across it. The converter terminals act as short-circuit if the converter stays in this mode for a long time and the voltage gain becomes zero.

### Process Mode

In this mode, switches are turned ON and OFF periodically in every switching cycle to process the power using the high frequency transformer. The leakage inductance of the transformer and switch output capacitance are used in this mode to obtain soft-switching operation for the converter. Furthermore, the diodes D₁ and D₂ which are normally used for bypass mode realization are used as clamp diodes in Process mode operation. Using a specific switching scheme, energy stored in the switch capacitances is restored by the clamp diodes.

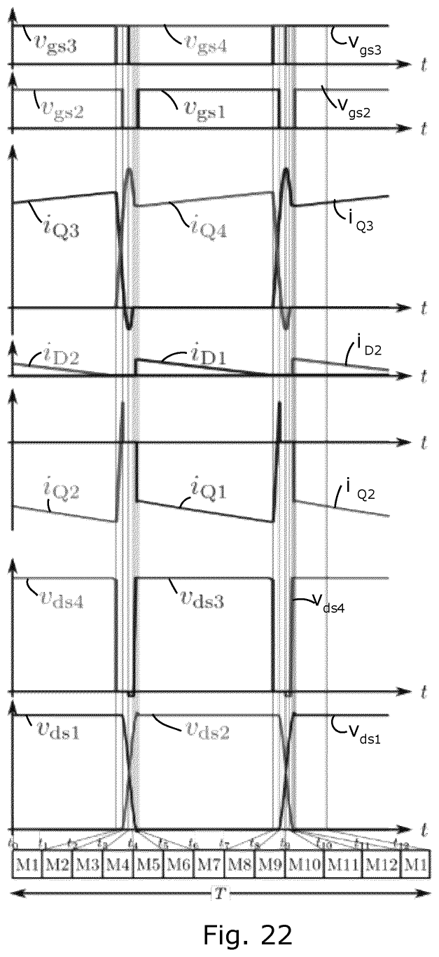

The switching scheme of the converter, its components voltage and current waveforms, and switching intervals during each switching period in this mode in an embodiment are shown in FIG. 22. The waveforms are obtained for the following assumptions. Capacitor C_{f} is large enough to keep the voltage constant during the switching cycle. Transformer magnetizing inductance is large enough to be ignored. Total transformer leakage inductance reflected to the string side is denoted by L_{lkg} which is shown on both of the string side windings with an inductance value of 0.5 L_{lkg}. Gate pulses for Q₃ and Q₄ are phase shifted by 180° and have duty cycles D>0.5 to avoid disruption of inductive filter's current. Gate pulses for Q₁ and Q₂ have 50% duty cycle with a deadtime inserted at the rising edge. Gate pulses for Q₁ and Q₂ are phase shifted by (D−0.5)×180° with respect to Q₄ and Q₃, respectively. The MOSFETs are modeled as an ideal switch with a parallel capacitor representing the output capacitance. Diodes are modeled as ideal diodes in series with a forward voltage drop. In this figure, V_{gs} refers to gate source voltage and v_{ds} refers to drain source voltage. Based on the assumptions, there are 12 switching intervals from which 6 switching intervals M7 to M12 are the complement of M1 to M6. Converter operation in each of the switching intervals M1 to M6 is described below:

M1 (t₀<t≤t₁), shown in FIG. 23A: This switching interval begins right after the dead time between Q₁ and Q₂. At the end of the dead time, voltage across Q₂'s output capacitance, i.e. Cₒₛₛ₂, has reached zero and the anti-parallel diode of Q₂ conducts the current through top left winding. Also, switch Q₃ was conducting prior to this interval, thus the string current, Iₛₜᵣ, was passing through Q₃ mainly. A small portion of Iₛₜᵣ was passing through the clamp diode D₂ because of turning off the switch Q₄. This interval begins with the turn ON of Q₂ which turns on with zero voltage switching (ZVS). When Q₂ is on, V_{PV} is applied on the top left winding resulting in a reflected voltage equal to 0.5V_{PV} on each of the bottom side windings. The major part of Iₛₜᵣ passes through the switch Q₃ and bottom left winding in this interval which loads the high-frequency transformer with a power of 0.5V_{PV} Iₛₜᵣ, i.e. half of the rated power of PV. Also, the small portion of Iₛₜᵣ which passes through the clamp diode D₂ discharges the leakage inductance L_{lkg} using the loop composed of PV, Q₃, leakage inductance, bottom side windings and the clamp diode D₂. Current of D₂ decays over the time due to the voltage drop of the diode and reaches to zero during the interval M1 (t₀<t≤t₁). In this interval, switches Q₁ and Q₄ are turned OFF and tolerate 21V_{PV} and V_{PV} voltage stresses, respectively. The capacitive filter is charged by I_{PV}−0.5 Iₛₜᵣ current whereas, the inductive filter is discharged by −(Vₒᵤₜ−0.5V_{PV}) voltage. This interval ends at t₁ when the switch Q₄ turns ON and Iₛtr starts to commutate to Q₄.

M2 (t₁<t≤t₂), shown in FIG. 23B: Switch Q₄ turns ON at the beginning of this interval and the overlap of the Q₃ and Q₄ is started to ensure that the inductive filter L_{f} current is not disrupted. Furthermore, switch Q₂ is ON and applies +V_{PV} on the top left winding of the transformer. The reflected voltage to the combination of bottom side windings of transformer is +V_{PV} that is applied on the leakage inductance as the switches Q₃ and Q₄ are ON and create a short circuit path for these windings. The voltage applied on the leakage inductance decreases the Q₃ current and increases the Q₄ current, thus it shifts the current from Q₃ to Q₄ with a slope determined by the value of leakage inductance. As can be seen, Q₄ turns ON with zero current switching (ZCS) and leakage inductance acts as a snubber for it to further reduce the switching losses. To balance the MMF within the core i_{Q2}=0.5 (i_{Q4}−i_{Q3}). Thus, when half of the overlap time is elapsed, Q₃ current equals the Q₄ current and the Q₂ current becomes zero. This is the end of M2 interval when Q₂ turns OFF with ZCS.

M3 (t₂<t≤t₃), shown in FIG. 23C: Switch Q₂ turns OFF at the beginning of this interval and the dead-time between Q₁ and Q₂ is started. Switch output capacitance (Cₒₛₛ) for Q₁ and Q₂ start to resonate with the leakage inductance which discharges Cₒₛₛ₁ and charges Cₒₛₛ₂. Until Cₒₛₛ₁ is not discharged to 0 or equivalently Cₒₛₛ₂ is not charged to V_{PV}, the resonance mode continues and causes the Q₃ current to become negative and (4 current to slightly go beyond Iₛₜᵣ. This interval ends at t₃ when Q₃ turns off with a negative current, thus its current diverts to the body diode and it turns OFF with zero voltage switching (ZVS).

M4 (t₃<t≤t₄), shown in FIG. 23D: In this interval, the leakage inductance current passes through Q₂ and the body diode of Q₃. The resonance between output capacitances of Q₁ and Q₂ continues in this interval. As Cₒₛₛ₁ is charged towards +2V_{PV} and Cₒₛₛ₂ is discharged towards zero, Q₃ current rises to zero and Q₄ current falls to Iₛₜᵣ. This relatively short interval ends at t₄ when the current of the body diode of Q₃ becomes zero.

M5 (t₄<t≤t₅), shown in FIG. 23E: In this interval, the body diode of Q₃ is turned off and its output capacitance Cₒₛₛ₃ along with Cₒₛₛ₁ and Cₒₛₛ₂ form a resonant circuit with leakage inductance. As Cₒₛₛ₃ charges towards V_{PV}, the leakage inductance current reaches its peak value in the resonance cycle. In order to avoid voltage ringing on Q₃, which deteriorates the converter efficiency and may cause converter failure due to voltage spikes, the clamp diode D₁ is added to clamp the Q₃ voltage to V_{PV} and recover the energy stored in the leakage inductance. This interval ends when the Q₃ voltage reaches V_{PV} and clamp diode D₁ turns ON.

M6 (t₅<t≤t₆), shown in FIG. 23F: Clamp diode D₁ starts conducting at the beginning of this interval and the leakage inductance current flows to the capacitive filter through D₁. As Cₒₛₛ₂ is not yet discharged to zero and Cₒₛₛ₁ is not fully charged to +2V_{PV}, the voltage across the PV side winding (combined top side windings) is less than +2V_{PV}. Thus, reflected voltage on the string side (bottom side windings) is less than +V_{PV} while the capacitive filter voltage is +V_{PV}. Then the difference of these two values is applied to the leakage inductance along with the voltage drop of diode D₁. This voltage drop decreases the current though the leakage inductance and diode. This interval ends at 16 when the Cₒₛₛ₂ is discharged to zero and Q₂ turns ON with the zero voltage switching (ZVS).

The intervals M7 to M12 are complements of the intervals M1 to M6 and the converter operation in these intervals operates in the same manner as described above, substituting right and left components, e.g. Q₃<->Q₄, Q₁<->Q₂, D₁<->D₂.

According to the principle of operation discussed in the embodiments above, converter switches always turn ON and OFF with soft switching in Process mode which results in higher efficiency and allows higher power densities. The converter operation here is described for m₂=2 and n₃=0 while other turns ratios are feasible. The only requirement on the turns ratio with the clamping capability described here is n₃=2−n₂, and any N₁, N₂, and N₃ that satisfies this constraint can be used.

The operation of the ISOP counterpart of the MIC is similar to the IPOS configuration that has been discussed here while the voltage and current stress of the switches might be different as a result of swapping the ports of the MIC from PV side to string side in the ISOP configuration.

### Control Implementation of the PEP-Based MIC Using Pulse Density Modulation

Embodiments of the control method optimize the PV power generation and perform MPPT by regulating the output voltage Vₒᵤₜ. MIC sets the Vₒᵤₜ between zero and V_{PV} to respond to the changes in PV power generation. If the converter operates in Bypass mode for a long time the output voltage Vₒᵤₜ becomes zero and the PV power generation is zero. If the converter operates in Pass-through mode for a long time, the output voltage Vₒᵤₜ becomes equal to the PV voltage V_{PV} and the PV power generation becomes IₛₜᵣV_{PV}. Assuming that n₂=n, if the converter operates in Process mode for a long time Vₒᵤₜ=V_{PV}(1−n/1) (i.e., voltage gain is 1−n/1), and PV power generation is

$${I}_{str} {V}_{PV} ( 1 - \frac{1}{n} ) .$$

For any PV power generation between zero

$${I}_{str} {V}_{PV} ( 1 - \frac{1}{n} ) ,$$

the controller allocates a time duration to the converters operation in each of the Process mode and Bypass modes so that desired voltage gain is obtained. Within the controller, time allocation between two modes can be implemented through a periodic signal with discrete controllable ON and OFF times which is also called pulse density modulation (PDM). If the duration of Process mode to the total duration of PDM cycle is denoted by D_{pdm}, then:

$${V}_{out} = {D}_{pdm} ( 1 - \frac{1}{n} ) {V}_{PV} . \qquad ( 3.2 )$$

Similarly, for any PV power generation between

$${I}_{str} {V}_{PV} ( 1 - \frac{1}{n} )$$

and IₛₜᵣV_{PV}, the controller sets the duration of the converter's operation in each of the Pass-through and Process modes using PDM. If the duration of Process mode to the total duration of PDM cycle is denoted by D_{pdm}, then:

$${V}_{out} = ( 1 - {D}_{pdm} / n ) {V}_{PV} . \qquad ( 3.3 )$$

In fact, using the proposed PV MIC, the converter only processes the power difference between Iₛₜᵣ V_{PV} and the current power generation of the PV panel.

### Design and Experimental Verification of the Proposed MIC

In this section, the component selection for the IPOS step-down MIC is done for a sample PV application. It is important to note that the MIC component ratings and the conversion ratio of the Process mode are imposed by the transformer turns ratio. As discussed in the Process mode section, n₃=2−n₂ is imposed by converter operation and transformer turns ratio is determined by selection of n₂=N₂/N₁. As N₂/N₁ approaches to 1:1 converter rating approaches the PV panel maximum power Ppr. However, for N₂/N₁ equal to n:1, the converter power rating becomes P_{PV}/n. Increasing n, the converter power rating decreases while the power deviation that can be compensated using Process mode also decreases to IₛₜᵣV_{PV}/n. The reduction of the power rating results in higher efficiency, power density, and lower cost for the PV MIC. However, it is important to note that Process mode is the most efficient operating mode of the MIC and selecting larger transformer turns ratio may reduce the energy capture of the PV system. Therefore, turns ratio is selected based on the statistical probability of the power mismatch on PV modules of a PV system. It is assumed for a PV system exposed to uneven shading that 50% power mismatch statistically covers the majority of the PV system operating points. Therefore, n₂=2 can be chosen to both save two windings in the MIC realization and cover the statistically important operating points of a PV system. Assuming a PV module open circuit voltage of 50 V, the maximum voltage on the Q₃ and Q₄ would be 100 V and assuming a power level of 200 W, the transformer can be designed to withstand the core and conduction losses using natural convection according to the design process given in [8]. Using these assumptions, A PV MIC is built with components details as given in Table 3.1.

TABLE 3.1
Components and part numbers used in the prototyped
high frequency and efficient partial power PV MIC

| Components | Part Number and description |
|---|---|
| Switches | GS61008T, 100 V Enhancement Mode |
| Q₁, Q₂, Q₃ and Q₄ | GaN |
| | Transistor, R_{ds(ON)} = 7 mΩ |
| Diodes D₁ and D₂ | CDBB5100-HF, Schottky |
| | Diode 100 V & 5 A |
| Magnetic Core | E32/6/20/R-3F4 + |
| | PLT32/20/3.2/R-3F4 |
| Capacitive | 16 × GRM188R61H225ME11D, |
| filter C_{f} | 2.2 μF 50 V |

### Experimental Verification

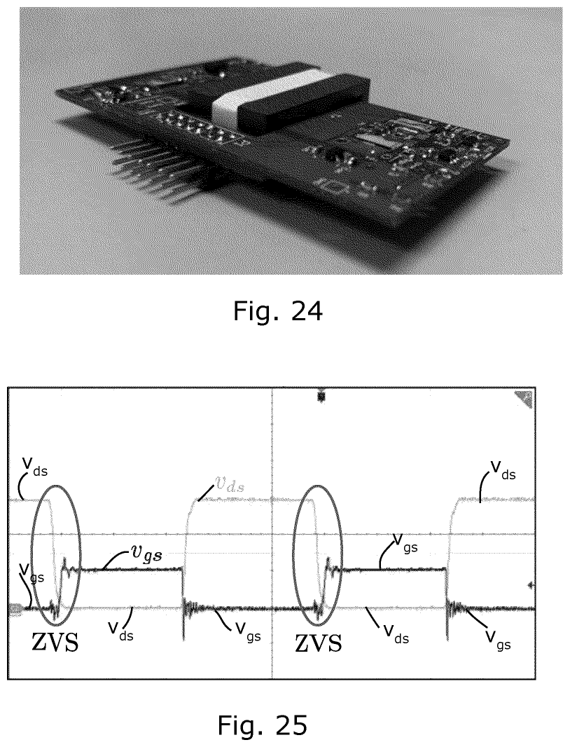

In this section, the proposed operation of an embodiment of the converter is experimentally verified using the prototyped MIC. The prototype MIC is built using the components listed in Table 3.1 and its picture is shown in FIG. 24. The ZVS operation of the switches Q₁ and Q₂ is experimentally verified according to FIG. 25. In this figure, the gate source voltage and drain source voltage of the switch Q₁ are shown. It can be seen that the drain source voltage of the switch reaches zero before the gate source voltage crosses the threshold voltage and allows the switch Q₁ to turn on with ZVS. The same scenario occurs for switch Q₂ and it operates with ZVS as well. As discussed earlier, switches Q₃ and Q₄ turn ON with ZCS and turn OFF with ZVS. FIG. 26 shows the switching waveforms for switch Q₃ and verifies its soft-switching operation. As can be seen, the gate source voltage of the switch has reached below the threshold voltage before the drain source voltage rise, therefore ZVS turn OFF is achieved for these switches. Also, at turn ON, there is no Miller plateau which indicates that there is not significant amount of current in the MOSFET channel when turning it ON and this confirms the ZCS turn ON for the switches Q₃ and Q₄. It is important to note that due to the high frequency operation switch currents cannot be directly measured.

As discussed earlier, PDM method is used for the MIC to perform the MPPT. The PDM has been implemented through a 32 pulse train system, where the PDM duty cycle can be defined

$${D}_{pdm} = \frac{{N}_{pdm}}{32} , {N}_{pdm} ∈ \{ 0 , 1 , 2 , … , 32 \} \qquad ( 3.4 )$$

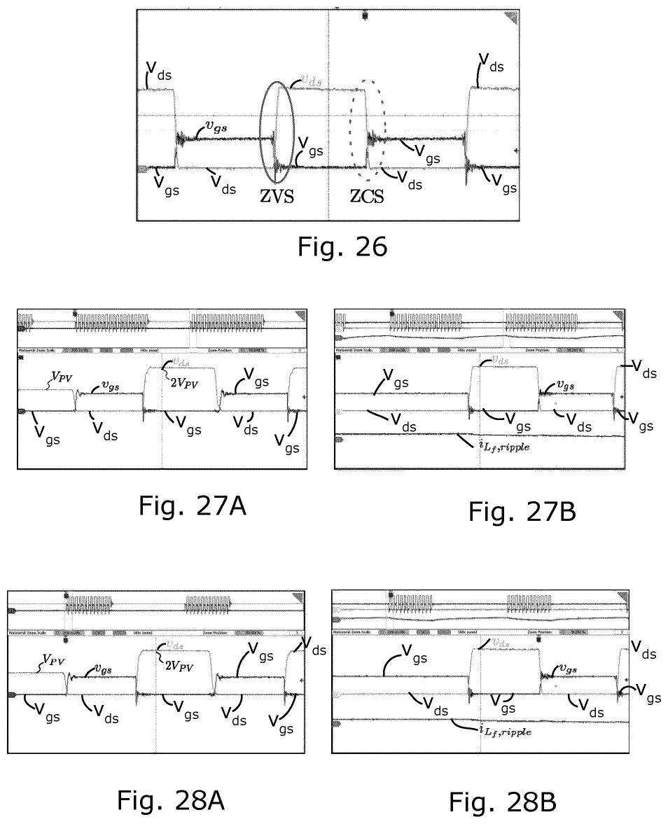

Switching waveforms of the switches Q₁ and Q₃ and input current ripple for Q₃ are shown for N_{pdm}=20 in FIG. 27A (Q₁) and FIG. 27B (Q₃), and for N_{pdm}=12 for FIG. 28A (Q₁) and FIG. 28B (Q₃). As can be seen the soft-switching operation of the switches is preserved under PDM operation and input current ripple is negligible. Also, it can be seen that the voltage across Q₁ drops to V_{PV} when both Q₁ and Q₂ are OFF while it is switched between zero and 2V_{PV} during the process mode. As the amplitude of the positive voltage across Q₁ does not change during the PDM cycle, it can be concluded that the voltage ripple is negligible.

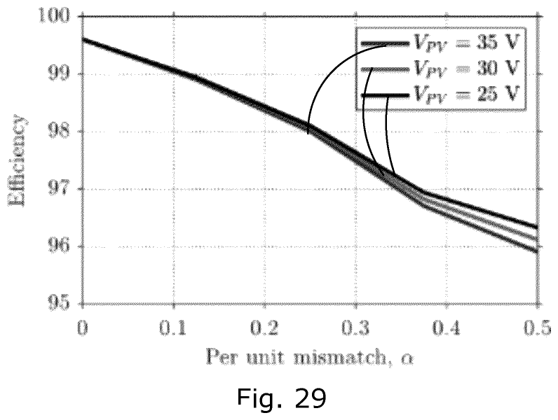

MIC efficiency for various power mismatch levels is also measured for the prototyped setup. In this test, PV rated power generation is assumed to be 220 W. To measure the efficiency the string current is maintained at the rated current and per unit power mismatch has been swept between 0 and 50%. The test has been repeated for three PV voltage levels of 25 V, 30 V, and 35 V, and the results are shown in FIG. 29. As can be seen, the efficiency is greater than or equal to 96% for all operating conditions and the slope of efficiency reduction with power mismatch is consistent for the whole range. The above observation can be more appreciated if it is compared to the regular PWM dc-dc MICs where efficiencies are normally below 95% and there is a huge step in efficiency when the MIC is operated slightly away from zero power mismatch.

In this patent document, embodiments of the partial energy processing (PEP) concept are presented as an extension to the existing partial power processing concept. Embodiments of the PEP concept allow more flexibility in the configuration to design high efficiency converters while the converter can be realized with almost the same components as basic partial power processing. The PEP is used to derive a voltage step-down PV MIC for the series connected PV panels. The PEP-based PV MIC achieves high efficiencies by operating converters in pairs and controlling their ON and OFF times rather than continuous duty cycle or frequency control. Compared to full power converters used as PV MICs, embodiments of the proposed converter gives higher efficiency all over the MPPT range and specially for close to unity voltage gains. Compared to DPP PV MICs, the proposed MICs process less power for ad large number of panels and do not need extra connections. Compared to common partial power PV MICs, embodiments of the proposed converter allows full range MPPT for the PV panel while it is still highly efficient. An experimental prototype of the PEP based PV MIC is built which achieves 97.6% to 99.8% efficiency and 12.4 kW/liter power density.

In this patent document, various PV system configurations have also been studied to exhibit the analysis and design requirements for dc-dc PV converters. It has been also concluded that the PV systems equipped with dc-dc MICs offer the best energy capture in the presence of power mismatch. Different dc-dc MIC categories are studied in this research considering both constant and variable dc bus voltage PV systems. It has been shown that for most of the applications, step-down MICs offer better performance such as larger string size, less processed power and component stress, lower number of MIC required in system level, etc.

In some embodiments, a new topology is developed for the MIC that renders soft-switching and offers high frequency operation and high efficiency. Rather than conventional duty cycle or frequency control for soft-switching converters, PEP is adopted to perform MPPT using the proposed MIC. This PEP method regulates the MIC conversion ratio by time modulation of the converter operation in three modes of operation which are called Pass-through, Bypass and Process modes. Using the proposed technique, MIC efficiency drop with conversion ratio reduction can be kept linear unlike the conventional PV MICs where a huge drop is observed around unity conversion ratio. Furthermore, the efficient operating modes of Pass-through and Process are used for high power and the statistically most probable range of the PV power generation, while full MPPT range is obtained using Bypass mode. Due to independence of these three modes, the MIC can be optimized for any PV power generation range that is statistically valuable while it is still able to cover the full MPPT range. A prototype MIC was built and tested to experimentally validate the operation and efficiency improvements.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the features being present. Each one of the individual features described here may be used in one or more embodiments and is not, by virtue only of being described here, to be construed as essential to all embodiments as defined by the claims.

1. A module integrated converter (MIC) comprising:
a positive input terminal;
a negative input terminal;
a positive output terminal;
a negative output terminal;
plural converters connecting the positive and negative input terminals to the positive and negative output terminals; and
the MIC being arranged to alter an allocation of power through the plural converters over time to control an overall voltage conversion ratio of the MIC.

2. The MIC of claim 1 in which the plural converters each have respective constant voltage conversion ratios.

3. The MIC of claim 1 in which the plural converters include a first converter, a second converter, and a dummy converter.

4. The MIC of claim 3 in which the first converter, a second converter, and a dummy converter are wired so that the first converter considered as a pair with the dummy converter is arranged either input parallel output series (IPOS) or input series output parallel (ISOP), and the second converter considered as a pair with the dummy converter is arranged either IPOS or ISOP.

5. The MIC of claim 4 in which both the first converter and the second converter are arranged IPOS with the dummy converter.

6. The MIC of claim 5 in which the positive output terminal and positive input terminal are ground.

7. The MIC of claim 5 in which the first converter and the second converter are wired so that the input and output terminals of the MIC are open circuit when the first converter and the second converter are both in respective OFF states.

8. The MIC of claim 4 in which the pair of the first converter with the dummy converter includes a connection of an input of the pair to supply a voltage directly to an output of the pair, the first converter also being configured to process power from the input to alter the voltage at the output of the pair.

9. The MIC of claim 4 in which the pair of the first converter with the dummy converter operates as a DC-DC transformer.

10. The MIC of claim 9 in which the DC-DC transformer includes:
a first switch;
a second switch;
a third switch;
a fourth switch;
a first inductor arranged in series with the first switch;
a second inductor arranged in series with the second switch;
a third inductor arranged in series with the third switch;
a fourth inductor arranged in series with the fourth switch;
the first inductor, second inductor, third inductor and fourth inductor being arranged on a common core;
the first switch and the second switch arranged in parallel connecting the positive input terminal to the negative input terminal;
the third switch and the fourth switch arranged in parallel connecting the negative output terminal to the negative input terminal or the positive output terminal to the positive input terminal.

11. The MIC of claim 10 in which the first switch and second switch are arranged to switch on at zero voltage.

12. The MIC of claim 10 in which the third switch and the fourth switch are arranged to switch on at zero current.

13. The MIC of claim 10 further comprising clamp diodes linking each of the third inductor and the fourth inductor to the positive output terminal, where the third switch and the fourth switch connect the negative output terminal to the negative input terminal, or to the negative output terminal, where the third switch and the fourth switch connect the positive output terminal to the positive input terminal, the clamp diodes being arranged in conjunction with the first, second, third and fourth inductors to clamp voltage across the third switch and the fourth switch.

14. The MIC of claim 13 further comprising additional inductors in series with the diodes, and in which the clamp diodes arranged to clamp voltage across the third switch and the fourth switch in conjunction with the first, second, third and fourth inductors and the additional inductors.

15. The MIC of claim 13 in which the pair of the second converter with the dummy converter includes one or more diodes arranged to allow current to pass between the negative output terminal and the positive output terminal.

16. The MIC of claim 15 in which the one or more diodes are the clamp diodes.

17. The MIC of claim 1 in combination with a solar panel, and arranged to control the overall voltage conversion ratio to achieve maximum power point tracking (MPPT) for the solar panel.

18. A DC-DC transformer comprising:
a positive input terminal;
a negative input terminal;
a positive output terminal;
a negative output terminal;
a first switch;
a second switch;
a third switch;
a fourth switch;
a first inductor arranged in series with the first switch;
a second inductor arranged in series with the second switch;
a third inductor arranged in series with the third switch;
a fourth inductor arranged in series with the fourth switch;
the first inductor, second inductor, third inductor and fourth inductor being arranged on a common core;
the first switch and the second switch arranged in parallel connecting the positive input terminal to the negative input terminal;
the third switch and the fourth switch arranged in parallel connecting the negative output terminal to the negative input terminal or the positive output terminal to the positive input terminal.

19. The DC-DC transformer of claim 18 in which the first switch and second switch are arranged to switch on at zero voltage.

20. The DC-DC transformer of claim 18 in which the third switch and the fourth switch are arranged to switch on at zero current.

21. The DC-DC transformer of claim 18 further comprising clamp diodes linking each of the third inductor and the fourth inductor to the positive output terminal, where the third switch and the fourth switch connect the negative output terminal to the negative input terminal, or to the negative output terminal, where the third switch and the fourth switch connect the positive output terminal to the positive input terminal, the clamp diodes being arranged in conjunction with the first, second, third and fourth inductors to clamp voltage across the third switch and the fourth switch.

22. The DC-DC transformer of claim 21 further comprising additional inductors in series with the diodes, and in which the clamp diodes arranged to clamp voltage across the third switch and the fourth switch in conjunction with the first, second, third and fourth inductors and the additional inductors.
